(19) United States
(12) Patent Application Publication
(10) Pub. No.: US 2010/0063947 A1
(43) Pub. Date: Mar. 11, 2010

(54) System and Method for Dynamically Adaptable Learning Medical Diagnosis System

(76) Inventors: Elizabeth S. Burnside, Madison, WI (US); Charles D. Page, Sun Prairie, WI (US); Jesse J. Davis, Madison, WI (US); Vitor Manuel de Morais Santos Costa, Porto (PT)

Correspondence Address: QUARLES & BRADY LLP, 411 E. WISCONSIN AVENUE, SUITE 2040, MILWAUKEE, WI, 53202-4497, US

(21) Appl. No.: 12/467,140

(22) Filed: May 15, 2009

Related U.S. Application Data
(60) Provisional application No. 61/053,853, filed on May 16, 2008.

(51) Int. Cl. G06F 15/18; G06Q 50/00

(52) U.S. Cl. 706/12; 705/3

(57) ABSTRACT

A system and method for determining a likelihood of a disease presence in a particular patient includes a patient history database containing records. Each record includes a plurality of data fields related to a particular patient. An analyzing network is provided having access to the patient history database and having features based on the plurality of data fields included in the records to analyze the plurality of data fields and determine a likelihood of disease presence based on the plurality of features. A learning network is provided that has access to the analyzing network to review the likelihood of disease presence determined by the analyzing network and the plurality of data fields included in the records and automatically identify, evaluate, and add new features to the analyzing network that improve determinations of a likelihood of the disease.

### CROSS-REFERENCE TO RELATED APPLICATIONS

This application is based on, claims the benefit of, and incorporates by reference U.S. Provisional Application Ser. No. 61/053,853 filed May 16, 2008, and entitled “SYSTEM AND METHOD FOR DYNAMICALLY ADAPTABLE LEARNING MEDICAL DIAGNOSIS SYSTEM.”

### STATEMENT REGARDING FEDERALLY SPONSORED RESEARCH

This invention was made with government support under Grant Nos. DOD ARPA F30602-01-2-0571 and NIH CA014520. The United States Government has certain rights in this invention.

### FIELD OF THE INVENTION

The invention relates to a system and method for automatically analyzing medical data to provide a diagnosis and, more particularly, to a system and method for dynamically adapting the criteria used with a learning medical diagnosis system.

### BACKGROUND OF THE INVENTION

Screening mammography has been the gold standard for breast cancer detection for over 30 years, and is the only available screening method proven to reduce breast cancer mortality. However the efficacy of mammographic screening is attenuated by significant variability of practice.

Studies have shown the impact of family history, age, hormone replacement therapy, menstrual and pregnancy history, and medical history on an individual's risk of breast cancer. Mammography findings increase or decrease this baseline risk. For example, breast density, the presence of a mass, and the presence of calcifications can all affect the post-test probability of various diseases of the breast. Physicians can calculate probabilities using Bayes' formula only if there are limited diagnostic parameters used to update the probability of a given disease. If the factors that modify the probability of disease become numerous and interact, physicians do not have the time or computational abilities to perform these calculations. They commonly rely on ad hoc decision-making strategies based on experience and memory that can be highly biased. The complexity of breast cancer diagnosis is continually increasing due to the explosion of medical technology and research in this area.

To aid in the analysis of mammographic images, a variety of systems have been developed that seek to aid the radiologist. For example, computer-aided, diagnosis (CAD) systems have been developed that attempt to analyze the images generated during a mammographic screening and provide feedback to the radiologist and/or other physician indicating potential markers of malignancy that should be reviewed. Over the years, these systems have been built, rebuilt, and refined, such that many now include complex neural networks and various analysis algorithms with which to analyze the images.

While these CAD systems are a useful tool for aiding a radiologist and/or other physician with reviewing the images acquired during the mammographic screening process, proper diagnosis by the radiologist and/or other physicians requires consideration of all available information, such as personal and familial medical histories, and use of this information as a lens through which to review the images and the CAD indicators. Due to the fact that this synthesis of information and ultimate analysis procedure is reliant upon the radiologist and/or other physicians, even when aided with CAD systems, the efficacy of mammographic screening is highly dependent upon the subjective abilities of radiologists and/or other physicians to synthesize and analyze information. Conventional implementations of CAD systems, for example, may have unanticipated negative affects on radiologist decision-making as they tend to defer recall when the systems fails to present particular marks or indications. Accordingly, the outcome of mammographic screening processes can be highly variable.

Therefore, it would be desirable to have a system and method for facilitating mammographic screening or other screening processes that provide increased accuracy and objectivity to the synthesis and analysis stages of diagnosis.

### SUMMARY OF THE INVENTION

The present invention overcomes the aforementioned drawbacks by changing the paradigm that is used in the diagnosis of breast cancer. Now, results are typically conveyed based on imaging studies, such as mammography, as positive or negative. In reality, the result of any test that is imperfect would ideally be expressed in terms of a post-test probability of disease. In this way, an individual can better understand their personal risk given the sensitivity and specificity of the study they are undergoing. The present invention provides a system and method that generates a post-test probability based on demographic risk factors and findings on a mammogram.

In accordance with one aspect of the invention, a system is disclosed for determining a likelihood of a disease presence in a particular patient. The system includes a patient history database containing records having a plurality of data fields related to a particular patient. The system also includes an analyzing network having access to the patient history database and having features based on the plurality of data fields included in the records to analyze the plurality of data fields and determine a likelihood of disease presence based on the plurality of features. A learning network is provided that has access to the analyzing network to review the likelihood of disease presence determined by the analyzing network and the plurality of data fields included in the records and automatically identify, evaluate, and add new features to the analyzing network that improve determinations of a likelihood of the disease.

In accordance with another aspect of the invention, a method is disclosed for developing a system for determining a likelihood of a disease. The method includes providing a database of patient records and building a Bayesian network to access the database of patient records, analyze a particular patient record in the database, and provide a likelihood of the disease in a patient corresponding to the particular patient record. The method further includes automatically augmenting the Bayesian network using a learning network to review the likelihood of the disease determined by the analyzing network and the patient records. The augmentation performed by the learning network includes adding new features to the Bayesian network that improve determinations of a likelihood of the disease.

In accordance with yet another aspect of the invention, a system is disclosed for determining a disease state that includes a patient history database containing records each having a plurality of data fields related to a particular patient. The system also includes a Bayesian network having access to the patient history database and having a plurality of features based on the plurality of data fields included in the records. The Bayesian network uses the features to analyze the plurality of data fields and determine a disease state of a particular patient. The system further includes a learning network having access to the Bayesian network to review the determined disease state and the plurality of data fields included in the records. Accordingly, the learning network automatically identifies and evaluates potential new features that, if added to the Bayesian network, would improve determinations of the disease state.

Various other features of the present invention will be made apparent from the following detailed description and the drawings.

### BRIEF DESCRIPTION OF THE DRAWINGS

FIG. 1 is a representation of a naïve Bayes model;

FIG. 2 is a representation of tree augmented naïve (TAN) Bayes model;

FIG. 3 is a schematic diagram of an automated expert analysis system in accordance with the present invention;

FIG. 4 is a representation of a potential structure of a Bayesian network for use in the automated expert analysis system of FIG. 3;

FIG. 5a is a diagram illustrating the learning of parameters for the expert-defined network structure, referred to hereafter as parameter learning;

FIG. 5b is a diagram illustrating the learning of the actual structure of the network in addition to its parameters, referred to hereafter as structure learning;

FIG. 5c is a diagram illustrating the use of a state-of-the-art in Statistical Relational Learning (SRL) technique and showing how relevant fields from other date fields (or even from other information sources) can be incorporated into the network, using aggregation if necessary;

FIG. 5d is a diagram illustrating a further example of the capabilities provided by the learning system, referred to hereafter as view learning;

FIG. 6 is a diagram showing an initial view-learning framework in accordance with the present invention;

FIG. 7 is a flow chart setting forth the steps for implementing a score-as-you-use (SAYU) protocol in accordance with the present invention;

FIGS. 8 and 9 are tables illustrating an example implementation of count aggregation in accordance with the present invention;

FIGS. 10 and 11 are tables illustrating an example implementation of linking in accordance with the present invention;

FIG. 12 is a flow chart setting forth the steps for implementing a clause search protocol and performing a score-as-you-use (SAYU), view-invention-by-scoring-tables protocol in accordance with the present invention;

FIG. 13 is a flow chart setting forth the steps for implementing an automated expert analysis system in accordance with the present invention; and

FIG. 14 is a graph showing example ROC curves constructed from BI-RADS categories of radiologists, and predicted probabilities of the Bayesian network.

### GENERAL DESCRIPTION OF THE TECHNOLOGY OF THE INVENTION

As will be described below, the present invention provides an expert analysis system utilizing a database, a Bayesian network, and a dynamically-adaptable learning system to build, control, and update the Bayesian network. A general description of some of the underlying conceptual technology employed within the framework follows herein before the detailed description of the present invention.

In general, a Bayesian network represents variables as nodes, which are data structures that contain an enumeration of possible values or states and store probabilities associated with each state. There are two approaches to building a Bayesian network. First, to use pre-existing knowledge about the probabilistic relationships among variables, and, second, to learn the probabilities and/or the structure from large existing data sets. Historically, investigators have typically used the former approach, however the present method allows for training a Bayesian network using existing clinical data. The training process may entail determining probabilities within each node as well as discovering which arcs connect the nodes to capture dependence relationships. Once trained, the Bayesian network may calculate a post-test probability of malignancy for each mammography finding using the structure and probabilities gleaned from the data. The structure of the Bayesian network may be updated, or otherwise modified by a dynamically-adaptable learning system.

To describe the configuration of a Bayesian network, upper case letters will be used to refer to a random variable and lower case letters will be used to refer to a specific value for that random variable. Given a set of random variables X={X₁, . . . Xₙ}, a Bayesian network B={G, θ} is defined as follows: G is a directed, acyclic graph that contains a node for each variable Xᵢ ∈ X. For each variable (node) in the graph, the Bayesian network has a conditional probability table θ_{XIIParents(XI)} giving the probability distribution over the values that variable can take for each possible setting of its parents, and θ={θ_{X1}, . . . θ_{Xn}}. A Bayesian network, B, encodes the following probability distribution:

$${P}_{B} ( {X}_{1} , … {X}_{n} ) = {\prod }_{i = 1}^{i = n} P ( {X}_{i} \vert Parents ( {X}_{i} ) ) . \qquad Eqn . 1$$

Two learning problems exist for Bayesian networks. The first learning task involves learning the parameters θ. That is, given Dataset, D, containing variables X₁, . . . Xₙ, Network structure, G, the problem is to learn θ_{XIIParents(XI)} for each node in the network.

One common approach to learning parameters is computing maximum likelihood estimates. One algorithm, the enhanced least resistance ELR algorithm, provides a mechanism for discriminative training of parameters. Another approach is to use a prior probability in conjunction with the maximum likelihood estimate. This is also known as an m-estimate. Given a dataset D, P(X=x) is given by the following formula:

$$P ( X = x ) = \frac{\hat{x} + m \times {p}_{x}}{n + m} ; \qquad Eqn . 2$$

where \hat{x} is the number of times that X=x in D, pₓ is the prior probability of X=x, and m is the term used to weight the relative importance of the prior distribution versus the empirical counts. One common approach to setting pₓ and m is known as the Laplace correction. This sets pₓ=1=k and m=k, where k equals the number of distinct settings for X.

The second learning task subsumes the first task, and involves learning the parameters θ as well as the network structure G. In this case, given, Dataset D that contains variables X₁, . . . Xₙ, the problem is to learn Network structure G and θ_{XIIParents(XI)} for each node in the network.

Popular structure learning algorithms include K2, BNC, tree augmented naïve Bayes, and the Sparse Candidate algorithm. In accordance with the present invention, it is contemplated that these existing techniques or others for constructing Bayesian networks for classification may be utilized. In accordance with one embodiment of the invention, both a naïve Bayes and tree augmented naïve (TAN) Bayes are utilized. In this case, a set of attributes A₁, . . . Aₙ, a class variable, C, and a dataset, D is assumed.

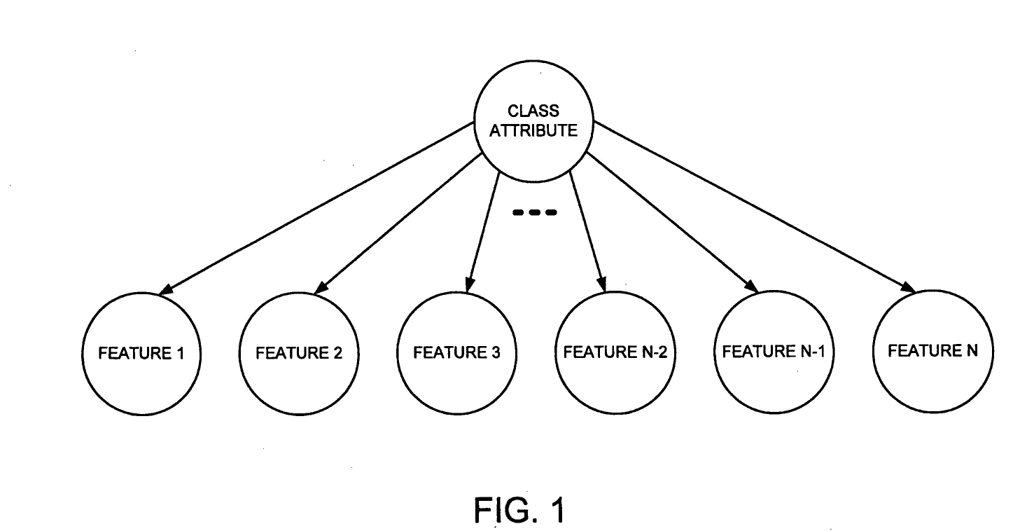

A representation of the naïve Bayes model is illustrated FIG. 1 in a relatively simple model that involves no learning to determine the network structure. Each attribute has exactly one parent, the class node. For naïve Bayes models, only the first learning task needs to be addressed. The drawback to using the naïve Bayes model is that it assumes that each attribute is independent of all other attributes given the value of the class variable.

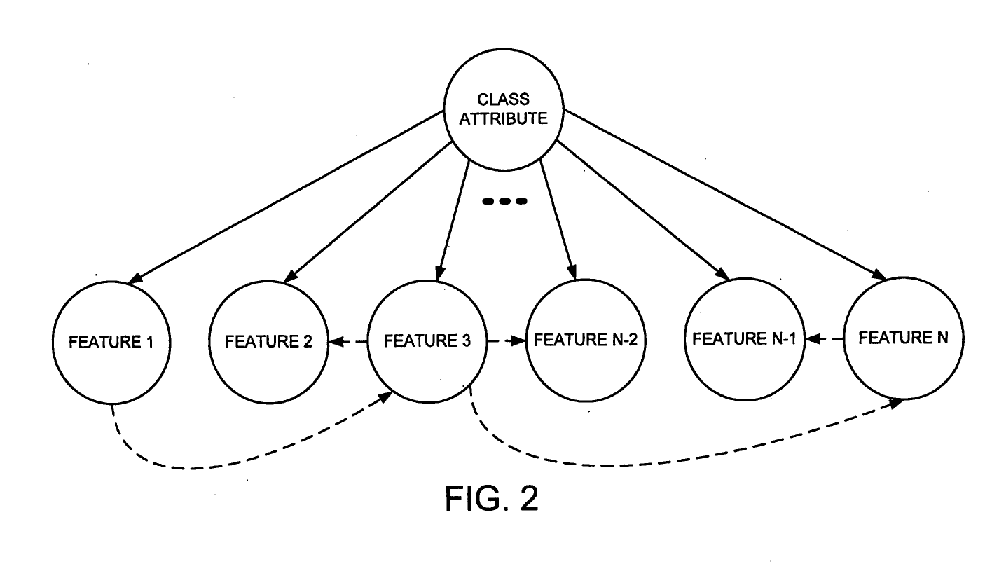

A TAN model, as illustrated in FIG. 2, retains the basic structure of naïve Bayes, but also permits each attribute to have at most one other parent. This allows the model to capture a limited set of dependencies between attributes. To decide which arcs to include in the augmented network, the algorithm constructs a complete graph G_{A}, between all non-class attributes Aiᵢ weights each edge between i and j with the conditional mutual information, CI|(Aᵢ, Aⱼ|C); finds a maximum weight spanning tree, T, over G_{A}; converts T into a directed graph, B, by picking a node and making all edges outgoing from it, and adds an arc in B connecting C to each attribute Aᵢ.

In the first step, CI represents the conditional mutual information, which is given as follows:

$$CI ( {A}_{i} ; {A}_{j} \vert C ) = {\sum }_{{a}_{i}}^{{A}_{i}} {\sum }_{{a}_{j}}^{A} {\sum }_{c}^{C} P ( {a}_{i} , {a}_{j} , c ) log \frac{P ( {a}_{i} {a}_{j} \vert c )}{P ( {a}_{i} \vert c ) P ( {a}_{j} \vert c )} . \qquad Eqn . 3$$

This algorithm for constructing a TAN model has two advantageous theoretical properties. First, it finds the TAN model that maximizes the log likelihood of the network structure given the data. Second, it finds this model in polynomial time.

Inductive logic programming (ILP) is a framework for learning relational descriptions. First-order logic relies on an alphabet including countable sets of: predicate symbols p/n, where n refers to the arity of the predicate and n≧0; function symbols f/n, where n refers to the arity of the function and n≧0; and variables.

A “term” is a variable or a function f(t₁, . . . , tₙ), where f has arity n and t₁, . . . , tₙ are terms. If p/n is predicate with arity n and t₁, . . . , tₙ are terms, then p(t₁, . . . , tₙ) is an “atomic formula.” A “literal” is an atomic formula or its negation. A “clause” is a disjunction over a finite set of literals. A “definite clause” is a clause that contains exactly one positive literal. A “definite program” is a finite set of definite clauses. Definite programs form the basis of logic programming.

ILP is appropriate for learning in multi-relational domains because the learned rules are not restricted to contain fields or attributes for a single table in a database. ILP algorithms learn hypotheses expressed as definite clauses in first-order logic. Commonly-used ILP systems include FOIL, Progol, and Aleph.

The ILP learning problem can be formulated as follows: given background knowledge B, a set of positive examples, E⁺, and a set of negative examples, E⁻, all expressed in first-order definite clause logic; learn a hypothesis, H, that includes definite clauses in first-order logic, such that B̂H|=E⁺ and B̂H|≠E⁻. In practice, it is often not possible to find either a pure rule or rule set. Thus, the ILP system may relax the conditions that B̂H|=E⁺ and B̂H|≠E⁻.

In accordance with one embodiment of the present invention and as described in detail below, the Aleph ILP system, which implements the Progol algorithm to learn rules, is used. This algorithm induces rules in two steps. Initially, the algorithm selects a positive instance to serve as the “seed” example. The algorithm then identifies all the facts known to be true about the seed example. The combination of these facts forms the example's most specific or saturated clause. The key insight of the Progol algorithm is that some of these facts explain this example's classification. Thus, generalizations of those facts could apply to other examples. The Progol algorithm then performs a top-down refinement search over the set of rules that generalize a seed example's saturated clause.

As described above, an ILP can be used to define new features for a propositional classifier. The present invention augments statistical relational learning (SRL) algorithms, which focus on learning statistical models from relational databases, by adding the ability to learn new fields, intensionally defined in terms of existing fields and intensional background knowledge.

SRL advances beyond Bayesian network learning and related techniques by handling domains with multiple tables, representing relationships between different rows of the same table, and integrating data from several distinct databases. SRL advances beyond ILP by adding the ability to reason about uncertainty. Research in SRL has advanced along two main lines: methods that allow graphical models to represent relations and frameworks that extend logic to handle probabilities.

Along the first line, algorithms have been created that learn the structure of probabilistic relational models (PRMs) which represented one of the first attempts to learn the structure of graphical models while incorporating relational information. Recently, others have discussed extensions to PRMs and compared them to other graphical models. Other graphical approaches include relational dependency networks and relational Markov networks.

PRMs upgrade Bayesian networks to handle relational data. A PRM relies on being provided with a relational skeleton: the database schema together with the objects present in the domain. It also specifies the attributes are associated with the objects, but it does not include the values for these attributes. In fact, a PRM models the joint distribution over possible settings that all the attributes of all the objects could take.

Along the second line, a statistical learning algorithm for probabilistic logic representations has been created as a general algorithm to handle log linear models. Additionally, others have provided learning algorithms for stochastic logic programs and a wide number of other variations, including Markov logic networks (MLNs).

MLNs combine first-order logic with Markov networks. Markov networks are undirected graphical models. Formally, an MLN is a set of pairs, (Fᵢ, wᵢ), where Fᵢ is a first-order formula and wᵢ ∈ R. MLNs soften logic by associating a weight with each formula. Worlds that violate formulas become less likely, but not impossible. Intuitively, as w increases, so does the strength of the constraint Fᵢ imposes on the world. Formulas with infinite weights represent a pure logic formula.

MLNs provide a template for constructing Markov networks. When given a finite set of constants, the formulas from an MLN define a Markov network. Nodes in the network are the ground instances of the literals in the formulas. Arcs connect literals that appear in the same ground instance of a formula.

As will be described below, an ILP-based feature construction can be used to address the weakness of many SRL frameworks. That is, SRL frameworks are recognized as suffering from being constrained to use only the tables and fields already in the database, without direct, human, modification. Specifically, many human users of relational databases find it beneficial to define further fields or tables that can be computed from existing ones. As will be described, the present invention provides a system and method to create these alternative “views” of the database automatically without human intervention and in a more consistent and encompassing manner than typically possible using human intervention. Hence, the present invention includes “view learning” described with respect to the application of creating an expert system in mammography.

### DETAILED DESCRIPTION OF THE INVENTION

The present invention, while applicable to a broad range of medical and non-medical diagnostic areas, is particularly advantageous when a large amount of data is available and maintained in a consistent manner. Accordingly, while applicable to a variety of areas, the present invention will be described with respect to the analysis of medical images and, particularly, breast imaging. Breast imaging is particularly applicable for use with the present invention because breast imaging, analysis, and diagnosis typically use a standardized lexicon, risk factors and imaging findings have been well studied, and accurate outcomes are generally determinable. Specifically, variability among mammography screening programs nationwide prompted the American College of Radiology (ACR) to develop the mammography lexicon, Breast Imaging Reporting and Data System (BI-RADS), to standardize mammogram feature distinctions and the terminology used to describe them. Studies show that BI-RADS descriptors impart diagnostic information valuable in discriminating benign and malignant breast diseases. Therefore, the present invention has been designed to take advantage of the BI-RADS lexicon to provide mammography interpretation and decision-making tools. However, the present invention is applicable to a wide-variety of medical and non-medical diagnostic areas.

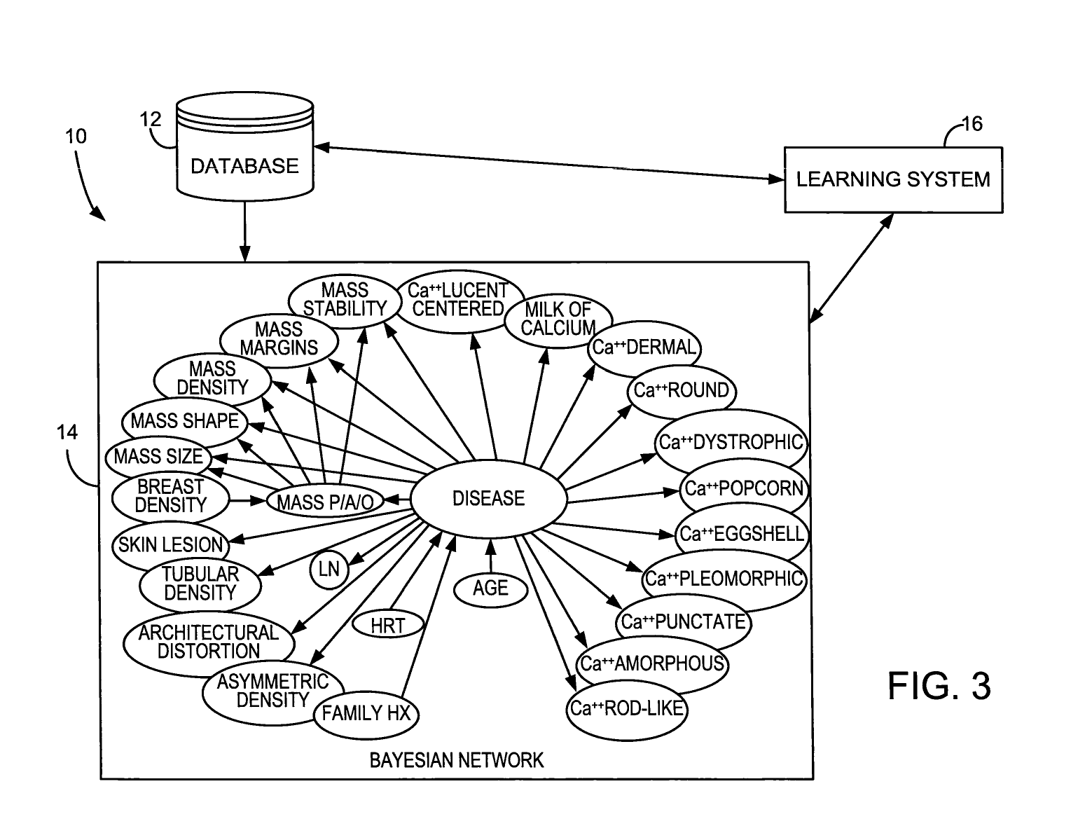

Referring now to FIG. 3, the present invention is illustrated in a simplified, high-level, block schematic of an expert system 10 in accordance with the present invention. The expert system 10 includes a database 12, a Bayesian network 14, and a learning system 16. The expert system of FIG. 3 is designed to aid a radiologist to approach the effectiveness of a sub-specialty expert, thereby minimizing both false negative and false positive results. To this end, the database 12 may include information using the BI-RADS lexicon or other standardized data sources.

The following table shows some fields from a main table (with some fields omitted for brevity) in the relational database portion of the database of mammography abnormalities 12. In accordance with one embodiment, the database 12 schema is specified in the National Mammography Database (NMD) standard established by the American College of Radiology (ACR).

| | | | Mass | | Mass | | Benign/ |
|---|---|---|---|---|---|---|---|
| ID | Patient | Date | Shape | . . . | Size | Location | Malignant |
| 1 | P1 | May, 2002 | Oval | | 3 mm | RU4 | B |
| 2 | P1 | May, 2004 | Round | | 8 mm | RU4 | M |
| 3 | P1 | May, 2004 | Oval | | 4 mm | LL3 | B |
| 4 | P2 | Jun, 2000 | Round | | 2 mm | RL2 | B |
| . . . | . . . | . . . | . . . | | . . . | . . . | . . . |

In one instance, the NMD may hold thousands of mammography examinations on thousands of patients. The records are described and recorded using BI-RADS by an interpreting radiologist at the time of mammography interpretation using structured reporting software. The software records patient demographic risk factors, mammography findings, and pathology from biopsy results in a structured format (for example, using point-and-click entry of information that populates the clinical report and the database simultaneously). The radiologist can also add details to the report by typing free text, but these details may not be captured in the database. Although the NMD format may contains many variables, only those that are routinely collected may be used by the present system. The following table illustrates exemplary variables for use in the present system.

| Variables | Potential Instances (Values) |
|---|---|
| Age | Age M < 45, Age 45-50, Age 51-54, Age 55-60, Age 61-64, >65 |
| Hormone Therapy | None, Less than 5 years, More than 5 years1 |
| Personal History of Breast | No, Yes |
| Cancer | |
| Family History of Breast | None, Minor, Strong2 |
| Cancer | |
| Breast Density | Class 1, Class 2, Class 3, Class 43 |
| Mass Shape | Circumscribed, III-defined, Microlobulated, Spiculated, Cannot |
| | discern |
| Mass Stability | Decreasing, Stable, Increasing, Cannot discern |
| Mass Margins | Oval, Round, Lobular, Irregular, Cannot discern |
| Mass Density | Fat, Low, Equal, High, Cannot discern |
| Mass Size | None, Small (<3 cm), Large (≧3 cm) |
| Lymph Node | Present, Not Present |
| Asymmetric Density | Present, Not Present |
| Skin Thickening | Present, Not Present |
| Tubular Density | Present, Not Present |
| Skin Retraction | Present, Not Present |
| Nipple Retraction | Present, Not Present |
| Skin Thickening | Present, Not Present |
| Trabecular Thickening | Present, Not Present |
| Skin Lesion | Present, Not Present |
| Axillary Adenopathy | Present, Not Present |
| Architectural distortion | Present, Not Present |
| Calc_Popcorn | Present, Not Present |
| Calc_Milk | Present, Not Present |
| Calc_RodLike | Present, Not Present |
| Calc_Eggshell | Present, Not Present |
| Calc_Dystrophic | Present, Not Present |
| Calc_Lucent | Present, Not Present |
| Calc_Dermal | Present, Not Present |
| Calc_Round | Scattered, Regional, Clustered, Segmental, Linearductal |
| Calc_Punctate | Scattered, Regional, Clustered, Segmental, Linearductal |
| Calc_Amorphous | Scattered, Regional, Clustered, Segmental, Linearductal |
| Calc_Pleomorphic | Scattered, Regional, Clustered, Segmental, Linearductal |
| Calc_FineLinear | Scattered, Regional, Clustered, Segmental, Linearductal |
| BI-RADS category | 0, 1, 2, 3, 4, 5 |

In the above table, HRT refers to estrogen based hormone replacement therapy. For the variable “Family History of Breast Cancer,” a value of “Minor” indicates non-first-degree family members diagnosed with breast cancer, and a value of “Major” indicates one or more first-degree family members diagnosed with breast cancer. For the variable “Breast Density,” a value of Class 1 indicates predominantly fatty, Class 2 indicates scattered fibroglandular densities, Class 3 indicates heterogeneously dense tissue, and Class 4 indicates extremely dense tissue. The value “Cannot discern” refers to missing data when the overall finding is present (e.g. mass margin descriptor is missing when mass size has been entered).

The NMD was designed to standardize data collection for mammography practices in the United States and is widely used for quality assurance.

Note that the database contains one record per abnormality. By putting the database into one of the standard database “normal” forms, it would be possible to reduce some data duplication, but only a very small amount of information (e.g., the patient's age, status of hormone replacement therapy and family history) could be recorded once per patient and date in cases where multiple abnormalities are found on a single mammogram date. Such normalization would have no effect on the present invention or results, so the present invention is described as operating directly on the database in its defined form.

The Bayesian network 14 may take many forms. As described above, Bayesian networks are probabilistic graphical models that have been applied to the task of breast cancer diagnosis from mammography data. Bayesian networks produce diagnoses with probabilities attached. Because of their graphical nature and use of probability theory, they are comprehensible to humans.

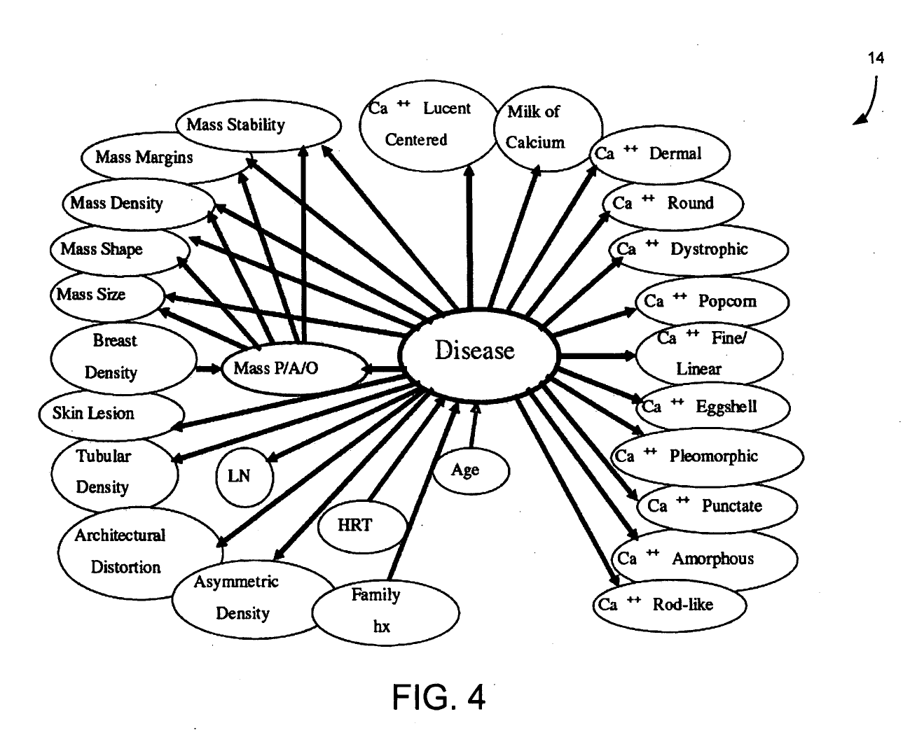

Referring now to FIG. 4, FIG. 4 illustrates a second structure of the Bayesian network 14. In FIG. 4, the root node, entitled “Breast Disease,” has two states representing the outcome of interest as being benign or malignant. The root node also stores the prior probability of these states (the incidence of malignancy). The remaining nodes in the Bayesian network represent various demographic risk factors, including various BI-RADS descriptors and categories. The Bayesian network may be configured to include various directed arcs to encode dependency relationships among variables.

Referring back to FIG. 3, beyond a Bayesian network 14 coupled with a large database 12, the present invention includes a learning system 16. As will be described, the learning system 16 is designed to review the Bayesian network 14 and data in the database 12 used by the Bayesian network 14 and automatically augment the Bayesian network 14 to identify new views, learn new rules, determine how to utilize new data fields included in the database 12, and generally improve the accuracy of predictions on unknown cases.

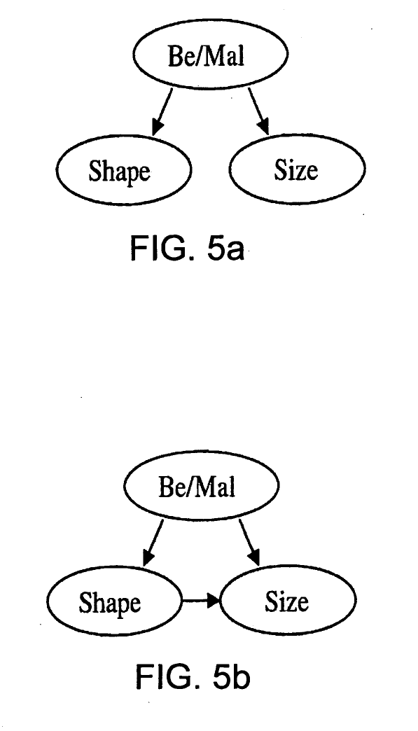

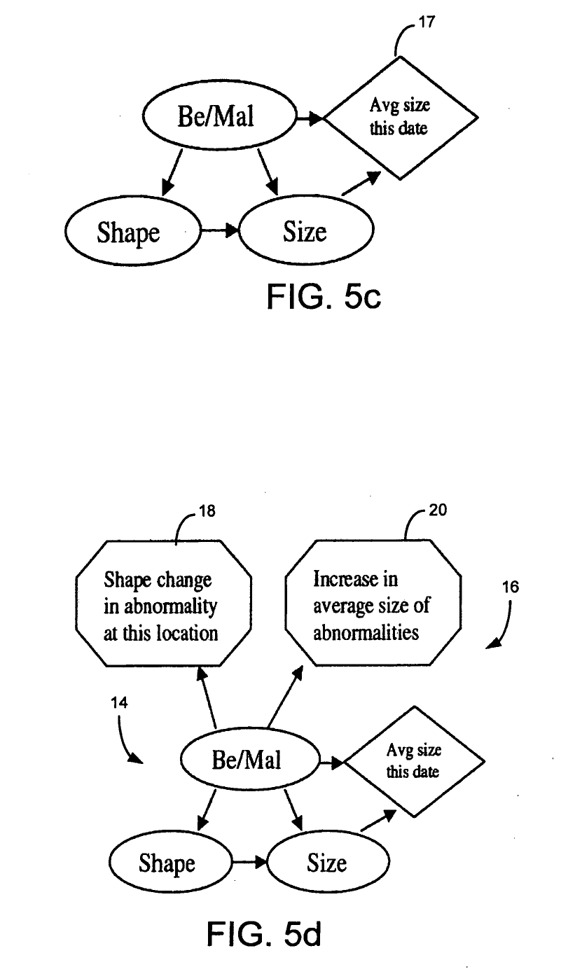

Referring now to FIGS. 5a-d, the expert system 10 of FIG. 3 is capable of a variety of learning types. In particular, FIGS. 5a and 5b show standard types of Bayesian network learning. FIG. 5a simply illustrates learning the parameters for the expert-defined network structure, referred to hereafter as parameter learning. FIG. 5b involves learning the actual structure of the network in addition to its parameters, referred to hereafter as structure learning. It should be noted that to predict the probability of malignancy of an abnormality, the Bayesian network uses only the record for that abnormality. However, data in other rows of the above-listed table may also be relevant. For example, radiologists may consider other abnormalities on the same mammogram or previous mammograms. That is, it may be useful to know that the same mammogram also contains another abnormality, with a particular size and shape or that the same person had a previous mammogram with certain characteristics. Incorporating data from other rows in the above-listed table is not possible with existing Bayesian network learning algorithms and requires SRL techniques, such as probabilistic relational models.

FIG. 5c illustrates the use of a state-of-the-art in SRL technique and shows how relevant fields from other rows of the above-listed table (or even from other tables) can be incorporated into the network, using aggregation if necessary. This type of learning will be referred to hereafter as aggregate learning. Rather than using only the size of the abnormality under consideration, a new aggregate field 17 is created that allows the Bayesian network 14 to also consider the average size of all abnormalities found in the mammogram.

In the illustrated example, numeric (e.g. the size of mass) and ordered features (e.g. the density of a mass) are selected from the database 12 and used to compute aggregates for each of these features. Aggregates can be computed on both the patient and the mammogram level. On the patient level, all of the abnormalities can be considered for a specific patient. On the mammogram level, only the abnormalities present on that specific mammogram are considered. To discretize the averages, each range can be divided into three bins. For binary features, predefined bin sizes can be used, while for the other features, equal numbers of abnormalities can be defined for each bin. For aggregation functions, maximum and average can be used.

Constructing aggregate features involves a three-step process. First, a field to aggregate must be chosen. Second, an aggregation function must be selected. Third, the particular rows to include in the aggregate feature, that is, which keys or links to follow must be selected. This is known as a “slot chain” in probabilistic relational model (PRM) terminology. In the mammography database 12, two such links exist. The patient ID field allows access to all the abnormalities for a given patient, providing aggregation on the patient level. The second key is the combination of patient ID and mammogram date, which returns all abnormalities for a patient on a specific mammogram and provides aggregation on the mammogram level. Using the example database 12 of FIG. 3 having 36 attributes and assuming 27 of the attributes are suitable for aggregation, the aggregation introduces 27×4=108 new features.

FIG. 5d illustrates a further example of the capabilities provided by the learning system 16, referred to hereafter as view learning. In FIG. 5d, a portion of the Bayesian network 14 is shown to illustrate how the addition of the learning system 16 can yield a new view that includes two new features utilized by the Bayesian network 14, which could not be defined simply by aggregation of existing features. The new features are defined by two learned rules that capture “hidden” concepts potentially useful for accurately predicting malignancy in breast images, but that are not explicit in the given database tables. One learned rule 18 defines that a change in the shape of an abnormality at a location since an earlier mammogram may be indicative of a malignancy. The other learned rule 20 defines that an “increase” in the average of the sizes of the abnormalities may be indicative of malignancy. Note that both rules require reference to other rows in the above-listed table for the given patient, as well as intensional background knowledge to define concepts such as “increases over time.” Neither rule can be captured by standard aggregation of existing fields in the database 12.

In accordance with one embodiment of the present invention, the learning system 16 includes the ILP system, Aleph, along with three new intensional tables that have been added into Aleph's background knowledge to take advantage of relational information. In the first new table, a “prior mammogram relation” is included to connect information about any prior abnormality that a given patient may have. In the second new table, a “same location relation” is included to provide a specification of the previous predicate. The “same location relation” adds the restriction that the prior abnormality must be in the same location as the current abnormality. This relation is facilitated by the fact that radiology reports include information about the location of abnormalities. In the third new table, an “in same mammogram relation” is included to incorporate information about other abnormalities a patient may have on the current mammogram.

By default, Aleph generates rules that would fully explain the examples. In contrast, the present invention is designed to implement view learning and, thereby, extract rules that would be beneficial as new views. The major challenge in implementing view learning in accordance with the present invention is to select information that would complement aggregate learning. Aleph's standard coverage algorithm is not designed for this application. Instead, the learning system 16 of the present invention is configured to first enumerate as many rules of interest as possible, and then pick useful rules. In order to obtain a varied set of rules, Aleph is run under the induce-max setting, which uses every positive example in each fold as a seed for the search. Also, it should be noted that it does not discard previously covered examples when scoring a new clause. Aleph learns several thousand distinct rules for each fold, with each rule covering many more malignant cases than (incorrectly covering) benign cases. To avoid errors caused by rule overfitting the present invention uses breadth-first search for rules and sets a minimal limit on coverage.

Each seed generates anywhere from zero to tens of thousands of rules. Adding all rules would require introducing thousands of often redundant features. To avoid this problem, the present system uses the following algorithm to select the particular rules to include in the model. First, all rules are scanned and duplicates and rules that perform worse than a more general rule are removed. This step significantly reduces the number of rules to consider. Next, the rules are sorted according to their assigned m-estimate of precision. In accordance with one embodiment of the present invention, Aleph's default value for m is used, which results in

m=\sqrt{positives+negatives} Eqn. 4;

where positives are the positives covered and the negatives are the negatives covered. Thereafter, the rule with the highest m-estimate of precision that covers an unexplained training example and covers a significant number of malignant cases is picked. This step is similar to the standard ILP greedy covering algorithm, except that it does not follow the original order of the seed examples. The remaining rules are then scanned and those that cover a significant number of examples, and that are different from all previous rules, even if these rules do not cover any new examples are picked. The rule selection is an automated process. Within this process, it is contemplated that the system may pick, for example, the top 50 clauses to include in the final learned model. Thereafter, the resulting views are incorporated as new features in the database.

Obviously, learning would not be necessary if the database initially contained all the potentially useful fields capturing information from other relevant rows or tables. For example, the database might be initially constructed to contain fields such as “slope of change in abnormality size at this location over time,” “average abnormality size on this mammogram,” and so on. However, it would require exhaustive resources for humans to identify all such potentially useful fields beforehand and define views containing these fields. Simply, all potentially statistically significant associations of information would need to be explored before building the database, which would impede creation of any database.

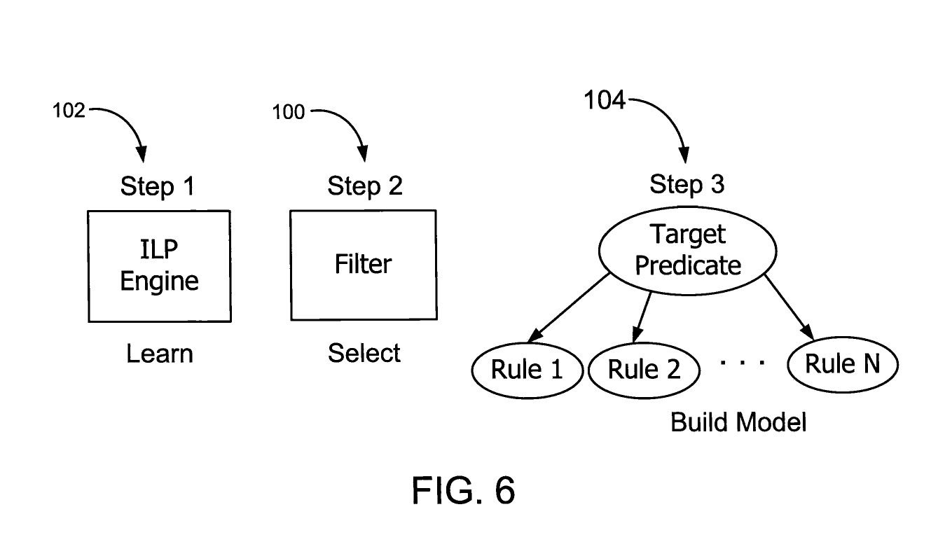

To create the learning system 16, as a first step, existing technology was utilized to obtain a view learning capability. The initial view-learning framework, illustrated in FIG. 6, works in three steps. First, at step 100 the view-learning framework learns rules to predict whether an abnormality is malignant. Second, at step 102 the view-learning framework selects the relevant subset of the rules to include in the model and extends the original database by introducing the new rules as “additional features.” More precisely, each rule will correspond to a binary feature such that it takes the value “true” if the body, or condition, of the rule is satisfied, and is otherwise indicated as “false.” In accordance with one embodiment, it is contemplated that a feature is “true” if it is true in a particular percentage of cases, for example, 5 percent. Third, at step 104, the view-learning framework runs a Bayesian network structure learning algorithm, allowing it to use these new features in addition to the original features, to construct a model.

With respect to the above-listed table of data, a potentially important piece of information a radiologist might use when classifying an abnormality found upon a review of ID 1 and ID 2, is the indicated increase in mass over time. An ILP system in accordance with the present invention could derive this concept by learning the following rule:

Abnormality, A, in mammogram, M, may be malignant if:

A has mass size S1, and

A has a prior abnormality A2, and

A is same location as A2, and

A2 has mass size S2, and

S1>S2.

Note that the last three lines of the rule refer to other rows of the relational table for abnormalities in the database 12. Hence, this rule encodes information not available to the initial version of the Bayesian network 14 built upon the original database 12. Using the present invention, this rule can be added as a field in a new view of the database 12 and consequently as a new feature in the Bayesian network 14.

As described above, a multi-step process for learning new views is provided in the present invention. In the first step of the process, an ILP algorithm learns a set of rules. In the second step, the process selects a relevant subset of rules for inclusion in the model. The third step constructs a statistical model, which includes the learned rules and the pre-existing features. While advantageous, this approach can be further improved. For example, the rule learning procedure is computationally expensive. Also, choosing how many rules to include in the final model is a difficult tradeoff between completeness and overfitting. Furthermore, the best rules according to coverage may not yield the most accurate classifier.

Accordingly, in some configurations, it may be advantageous to construct a classifier as the rules are learned. This approach scores rules by how much they improve the classifier, which provides a tight coupling between rule generation and rule usage. This methodology will be referred to hereinafter as “score as you use” (SAYU). The SAYU methodology represents a general framework for dynamically constructing relational features for a propositional learner. In principle, SAYU could be implemented with any feature construction method and any propositional learning.

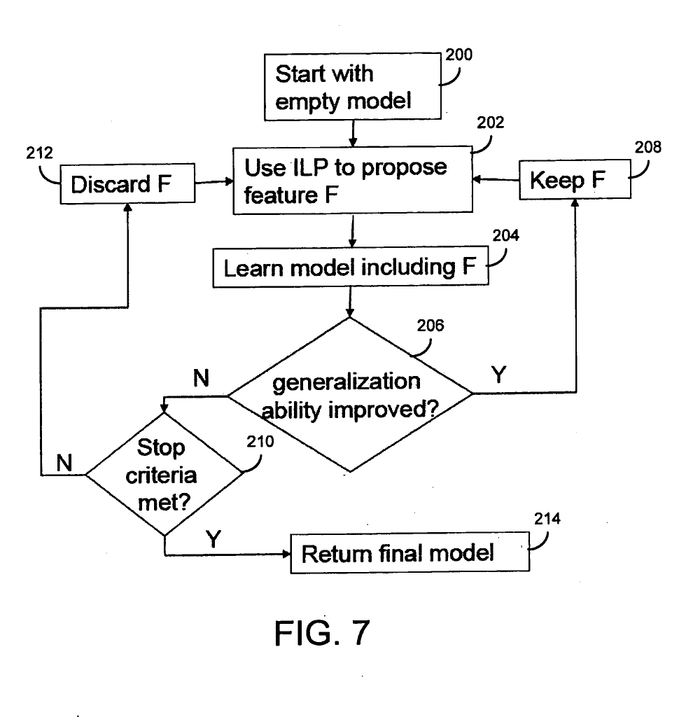

Referring to FIG. 7, the SAYU approach starts at process block 200 using an empty model or a prior model. Next, an ILP system generates rules at process block 202. Each rule represents a new feature (F) to be added to the current model. Thereafter, the SAYU system evaluates each feature in the following manner. At process block 204, the system extends the attributes available to the propositional learner with the rule proposed by the ILP system. That is, the propositional learner constructs a new model using the extended feature set. Next, the generalization is evaluated at decision block 206 to determine the ability of the model extended with the new feature. If the features do improve the ability of the generalization to provide accurate information, the feature is retained at process block 208 and the process reiterates until an augmented features does not improve the generalization. In this case, at decision block 210, the system determines whether a stop criteria, or negative variation threshold, has been reached. That is, if the feature does not improve the generalization, but the stop criteria indicating that the model cannot be improved by a different feature has not yet been reached, the feature is discarded at process block 212 and the ILP proposes a new feature at process block 202. On the other hand, if the stop criteria have been met, indicating that further new features proposed by the ILP will probably not improve the model at this time, the model is finalized at process block 214.

The initial goal of the SAYU is to develop a classification system. In accordance with one aspect of the invention, the SAYU implementation uses the Aleph ILP system as a rule proposer and naïve Bayes or TAN as propositional learners. As described above, if a rule is accepted, or the search space is exhausted, SAYU randomly selects a new seed and re-initializes Aleph's search. Thus, it is not searching for the best rule, but the first rule that improves the model. However, the SAYU allows the same seed to be selected multiple times during the search.

The above-described SAYU approach for constructing relational features and building statistical models improves the multi-step approach described above by only selecting rules that improve the performance of the statistical classifier that is being constructed. SAYU overcomes the computation cost in two ways. First, it uses simple statistical models. Second, it is able to find small rule sets containing short rules that perform well. SAYU can find these theories with very little search. However, this implementation of the SAYU approach serves only as a rule combiner, not as a tool for view learning that adds fields to the existing set of fields (features) in the database. This general SAYU approach can be modified to take advantage of the predefined features and yield a more integrated approach to View Learning.

As referred to herein, “SAYU-View” starts from the Level 3 network. SAYU-View uses the training set to learn the structure and parameters of the Bayes net, and the tuning set to calculate the score of a network structure. This multi-step approach uses the tune set to learn the network structure and parameters. In particular, in order to retain a clause in the network, the integral of a precision-recall curve of the Bayes net incorporating the rule must achieve at least a two percent improvement over the area of the precision-recall curve of the best Bayes net. The main goal is to use the same scoring function for both learning and evaluation, so the area under the precision-recall curve is used as the score metric. In accordance with one embodiment, the area under the precision-recall curve metric integrates over recall levels of 0.5 or greater. Therefore, SAYU-View extends SAYU to enable the system to begin with an initial feature set. As tested, SAYU-View results in significantly more accurate models on the mammography domain. Specifically, SAYU-View performs better than an SRL approach that only uses aggregation.

While the above-described multi-step, SAYU, and SAYU-View approaches are highly advantageous in a number of applications, they may not perform ideally in other applications. Specifically, these approaches only create new fields, not new tables. Furthermore, the new fields are learned approximations to the target concept.

As will be described, the present invention provides a mechanism for learning a new view that includes full new relational tables, by constructing predicates that have a higher-arity than the target concept. Furthermore, the present invention is capable of learning predicates that apply to different types than the target concept. The latter, provides the advantageous ability to develop new predicates that are unrelated to the target concept. Further still, as will be described, the present invention permits a newly-developed relation, or predicate, to be used to develop other new relations. Such re-use goes beyond simply introducing “short-cuts” in the search space for new relations. That is, because the new approach also permits a relation to be from aggregates over existing relations, re-use actually extends the space of possible relations that can be learned by the approach. This extension of SAYU, will be referred to herein as SAYU-VISTA because it provides a mechanism for View Invention by Scoring TAbles (VISTA).

In many domains, discovering intermediate hidden concepts can lead to improved performance. For instance, consider the well-known task of predicting whether two citations refer to the same underlying paper. A relation based on “CoAuthor” may be potentially useful for disambiguating citations; for example, if S. Russell and S. J. Russell both have similar lists of coauthors, then perhaps they are interchangeable in citations. But the CoAuthor relation may not have been provided to the learning system. Furthermore, CoAuthor can be used as a building block to construct further explicit features for the system, such as a new predicate SamePerson. A preferable learning algorithm should be able to discover and incorporate relevant, intermediate concepts into the representation. As will be described SAYU-VISTA provides this capability.

SAYU-VISTA and SAYU both learn definite clauses and evaluate clauses by how much they improve the statistical classifier. The key difference in the algorithms rests in the form that the head of the learned clauses takes. In SAYU, the head of a clause has the same arity and type as the example, which allows the system to precisely define whether a clause succeeds for a given example and, hence, whether the corresponding variable is true. In the mammography domain, a positive example has the form malignant(ab1), where ab1 is a primary key for some abnormality. Every learned rule has the head malignant(A) such as in the following rule:

malignant(Ab1) if:
ArchDistortion(Ab1, present),
same_study(Ab1, Ab2),
Calc_FineLinear(Ab2, present).

The Bayesian network variable corresponding to this rule will take value “true” for the example malignant(ab1), if the clause body succeeds when the logical variable A is bound to ab1.

As will be described, SAYU-VISTA removes the restriction that all the learned clauses have the same head. First, SAYU-VISTA learns predicates that have a higher arity than the target predicate. For example, in the mammography domain, predicates such as p11(Abnormality1, Abnormality2), which relate pairs of abnormalities, are learned. Second, SAYU-VISTA learns predicates that have types other than the example key in the predicate head. For example, a predicate p12(Visit), which refers to attributes recorded once per patient visit, could be learned.

First, the concept of scoring predicates that have higher-arities than the target relation will be discussed. Then, the concept of learning predicates that have types other than the example key in the predicate head will be discussed. In order to score predicates of this form, the concept of “Linkages” will be discussed. After discussing these concepts, a full implementation for the SAYU-VISTA algorithm applied to mammography applications will be discussed.

Scoring Higher-Arity Predicates

SAYU-VISTA can learn a clause such as:
p11(Ab1,Ab2) if:
   density(Ab1,D1),
   prior-abnormality-same-loc(Ab1,Ab2),
   density(Ab2,D2),
   D1>D2.

This rule says that p11, some unnamed property, is true of a pair of abnormalities, Ab1 and Ab2, if: (1) they are at the same location, (2) Ab1 was observed first, and (3) Ab2 has higher density than Ab1. Thus, p11 may be thought of as “density increase.” Unfortunately, it is not entirely clear how to match an example, such as malignant(ab1), to the head of this clause for p11. SAYU-VISTA maps, or links, one argument to the example key and aggregates away any remaining arguments using existence or count aggregation.

To illustrate the “exists” operator, consider predicate p11, given above. In this clause variable Ab1 represents the more recent abnormality. Suppose a feature for this clause was created using existence aggregation. The feature is true for a given binding of Ab1, if there exists a binding for Ab2 that satisfies the body of the clause. Specifically, for an example malignant(ab1), this “density increase” feature is true, if there exists another abnormality ab2 such that “density increase” is true of the tuple <ab1,ab2>.

Using the same clause and same example abnormality ab1, the count operator can be considered. In this case, the number of solutions for B given that A is set to ab1 is of interest. This means that the new feature that will be proposed is not binary. Currently, VISTA discretizes aggregated features using a binning strategy that creates three equal-cardinality bins, where three was chosen arbitrarily before the running of any experiments.

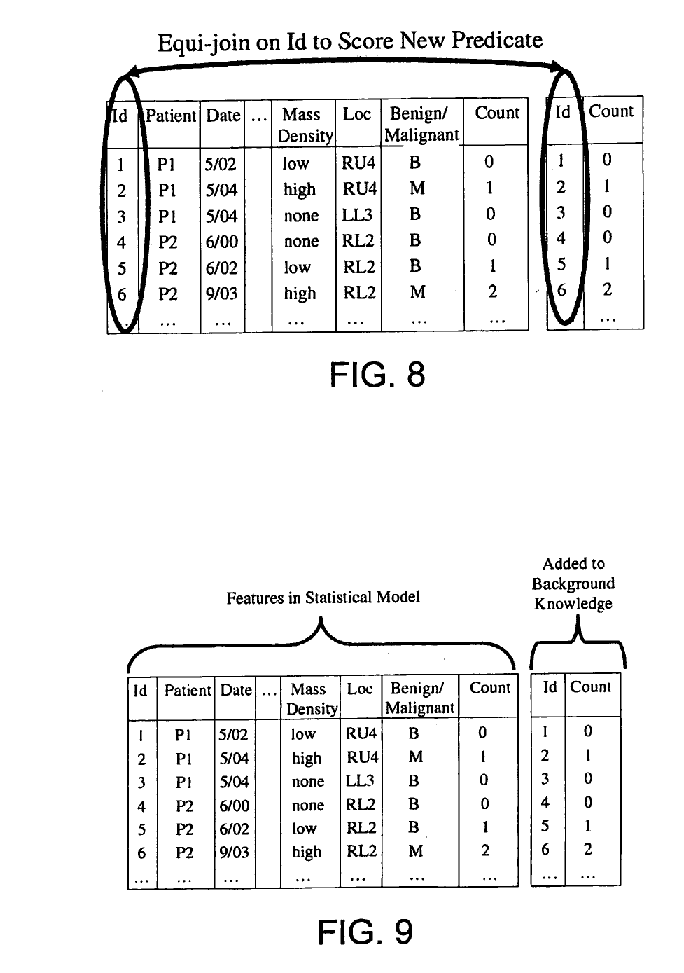

Referring now to FIGS. 8 and 9, scoring p11 with count aggregation can be described. Specifically, referring to FIG. 8, to score p11 using count aggregation, joins are made on Id to introduce the feature into the statistical model. Referring to FIG. 9, if p11 is accepted, it will remain in the statistical model. Its definition will be added to the background knowledge, allowing for reuse in the future.

Aggregation queries are, in general, more expensive to compute than standard queries, as it may be necessary to compute all solutions, instead of simply proving satisfiability. Thus, using aggregated views when inventing new views can be very computationally expensive. To address this problem, whenever VISTA learns an aggregated view, VISTA does not store the learned intensional definition of the view. Instead, VISTA materializes the view. That is, VISTA computes the model and stores the logical model as a set of facts. This solution consumes more storage, but it makes using aggregated views as efficient as using any other views.

Linkages

So far it has been assumed that the first argument to the learned predicate has the same type as the example key. In the above examples, this type has been “abnormality id.” However, using VISTA, there is no need to enforce this limitation. For example, in predicting whether an abnormality is malignant, it might be useful to use the following clause, where “Patient” is a key that accesses patient level information:

p12(Patient):—
history_of_breast_cancer(Patient),
prior_abnormality(Patient, Ab),
biopsied(Ab, Date).

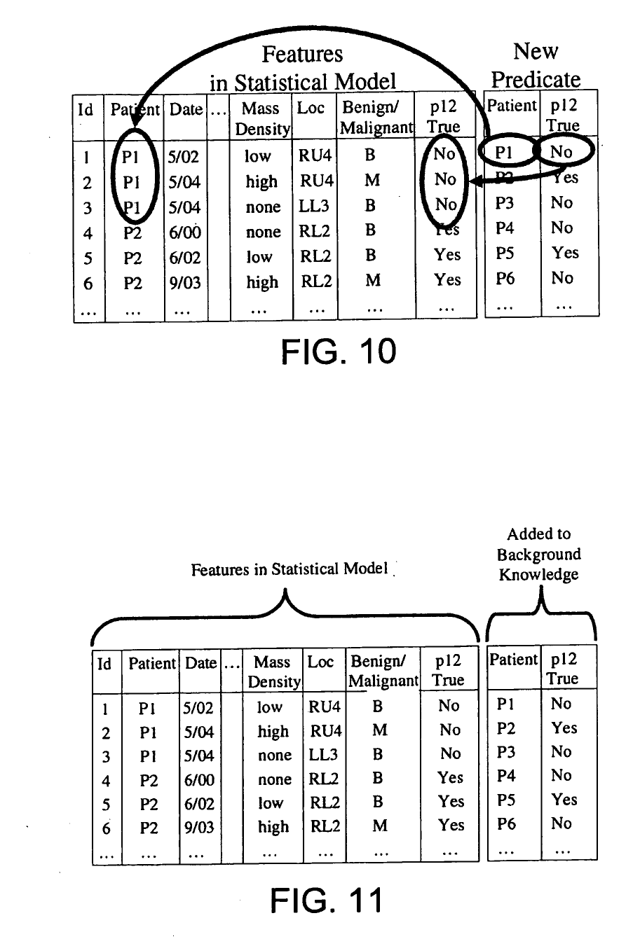

In this example, predicate p12 is true of a patient, who has a family history of breast cancer and previously had a biopsy. Linkage declarations are background knowledge that establish the connection between objects in the examples and objects in the newly invented predicates. When these objects are of the same type, the linkage is trivial; otherwise, it must be defined. For mammography, linkage definitions are used to connect an abnormality to its patient or to its visit (mammogram). Referring now to FIGS. 10 and 11, scoring p12 can be achieved by linking from a patient back to an abnormality. Specifically, FIG. 10 shows that a link can be formed from a patient back to an abnormality. The value of the “Had Biopsy” for key P1 in the “New Predicate” relation gets applied to each row associated with P1 in the statistical model. Accordingly, referring to FIG. 11, if p12 is accepted, it will remain in the statistical model. Its definition will be added to the background knowledge, allowing for reuse in the future.

Predicate Learning Algorithm

At a high level, SAYU-VISTA learns new predicates by performing a search over the bodies of definite clauses and selecting those bodies that improve the performance of the statistical model on a classification task. In accordance with the present invention as applied to mammography, the tree-augmented naïve Bayes (TAN) is preferably used as the statistical model. The predicate invention algorithm takes several inputs from a user, such as:

1. A training set, to learn the statistical model.

2. A tuning set, to evaluate the statistical model.

3. A pre-defined set of distinguished types, which can appear in the head of a clause.

4. Background knowledge, which must include linkage definitions for each distinguished type.

5. An improvement threshold, p, to decide which predicates to retain in the model.

6. An initial feature set, which is optional.

In accordance with the present invention, a new predicate must improve the model's performance by at least “p” percent in order to be kept. In accordance with one embodiment, p=2 can be used in all experiments. Following hereafter is a set of pseudo code for the SAYU-VISTA algorithm:

```
  Input: Train Set Labels T, Tune Set Labels S, Distinguished Types D,
Background Knowledge B, Improvement Threshold p, Initial Feature
Set Fᵢₙᵢₜ
  Output: Feature Set F, Statistical Model M
  F = Fᵢₙᵢₜ;
  BestScore = 0;
  while time remains do
    Randomly select the arity of predicate to invent;
    Randomly select types from D for each variable in the head of the
    predicate;
    SelectedFeature = false;
    while not(SelectedFeature) do
      Predicate = Generate next clause according to breadth first
      search;
      /* Link the predicate back to the target relation */
      LinkedClause = Link(Predicate, B);
      /* Convert the LinkedClause into a feature that the statistical
      model can use */
      NewFeature = aggregate(LinkedClause, T, S);
      F_{new} = F ∪ NewFeature;
      M_{new} = BuildTANNetwork(T, Fnew);
      NewScore =AreaUnderPRCurve(M, S, Fnew);
      /* Retain this feature */
      if (NewScore > (1 + p) * BestScore) then
        F = F_{new};
        BestScore = NewScore;
        M = M_{new};
        Add predicate into background knowledge;
        SelectedFeature = true;
      end
    end
  end
```

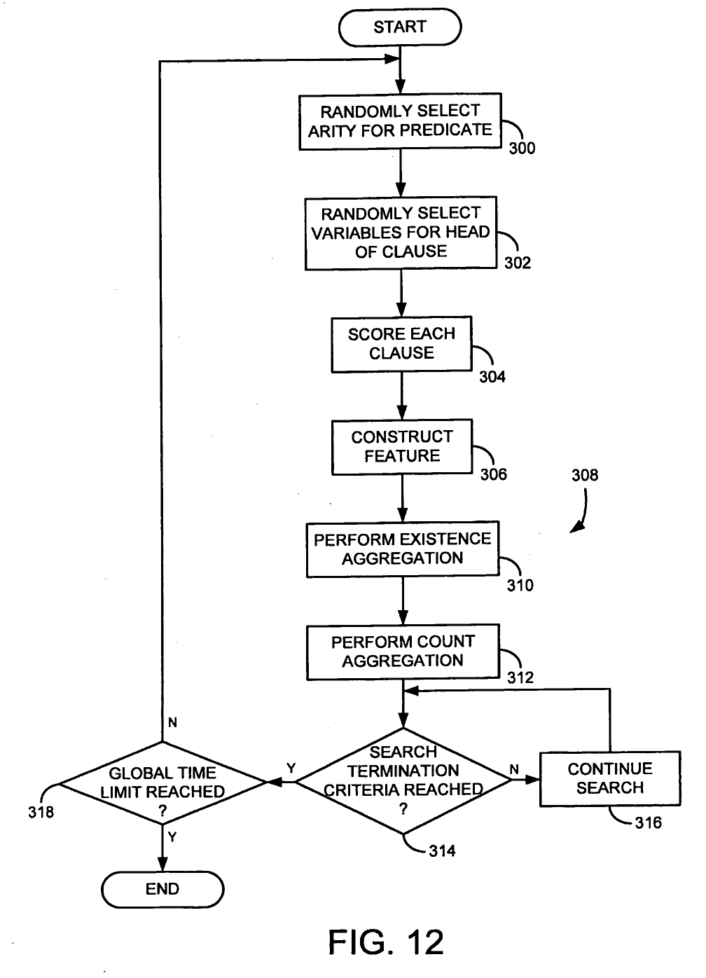

Referring now to FIG. 12, the clause search proceeds as follows. An arity is randomly selected for the predicate at process block 300. To limit the search space, the arity is restricted to be either the arity of the target relation, or the arity of the target relation plus one. Next, the types for the variables that appear in the head of the clause are randomly selected at process block 302. In accordance with one implementation, the clause search uses a top-down, breadth-first refinement search. The space of candidate literals are defined to add using modes. At process block 304, each proposed clause is scored by adding it as a variable in the statistical model and, at process block 306, a feature is constructed. To construct the feature, the predicate is first linked back to the example key as described above with respect to the “linkages” section.

Aggregation is then performed, as indicated by arrow 308 and as described above with respect to the “scoring higher-arity predicates” section, to convert the clause into a feature. By default, the algorithm first tries existence aggregation, as indicated at process block 310, and then tries count aggregation, as indicated at process block 312. The clause search terminates at decision block 314 in the event of reaching one of three cases: (i) it finds a clause that meets the improvement threshold; (ii) it fully explores the search space; or (iii) it exceeds the clause limit. Else, the search continues at process block 316. As previously described with respect to FIG. 7, the algorithm adds every clause that meets the improvement threshold into the background knowledge. Similarly, after satisfying one of the termination conditions, the algorithm re-initializes the search process until a global time limit is reached at decision block 318. Therefore, future predicate definitions can re-use previously learned predicates.

SAYU-VISTA generates more accurate models than both SAYU and MLNs. Additionally, SAYU-VISTA is able to build these models much faster than MLNs. SAYU-VISTA constructs interesting intermediate concepts. In particular, subsets of the variables in the clause body may be mapped back to an example's key, via the domain-specific linkage relations. This enables learning of new tables or non-unary predicates that have different arities and types than the examples. Also, to score each potential new table or predicate, SAYU-VISTA constructs an entire statistical model, and only retains the new predicate if it yields an improved model. Further still, learned predicates are available for use in the definitions of further new predicates.

Therefore, the present invention provides a system and method that extends view learning in a variety of ways. First, it creates predicates that have a higher-arity than the target concept, which capture many-to-many relations and require a new table to represent. Second, it constructs predicates that operate on different types than the target concept, allowing it to learn relevant, intermediate concepts. Third, it permits newly-invented predicates to be used in the invention of other new relations.

It is contemplated that the present invention may be utilized in a number of ways. In particular, it is contemplated that the learning network may be selectively utilized. In one aspect of the invention, the learning network may be utilized to build the Bayesian/analyzing network. In this case, the learning network is used to build the Bayesian/analyzing network and, once built, the learning network is disabled. In another aspect of the invention, the learning network may be utilized after the Bayesian/analyzing network is built. For example, the learning network may be periodically utilized to maintain or update the Bayesian/analyzing network when new data categories are added to the database.

SAYU-VISTA's view learning capability provides a mechanism for predicate invention, a type of constructive induction investigated within ILP. In other implementations, the space of new views that can be defined for a given relational database is vast, which can raise problems of overfitting and search complexity. SAYU-VISTA constrains this space by learning definitions of new relations (tables or fields) one at a time, considering only new relations that can be defined by short clauses expressed in terms of the present view of the database (including background knowledge relations provided as intensional definitions), and re-constructing the SRL model when testing each potential new relation, and keeping a new relation only if the resulting SRL model significantly outperforms the previous one. The last step includes matching a subset of the arguments in the relation with the arguments in the data points, or examples, and aggregating away the remaining arguments in the relation.

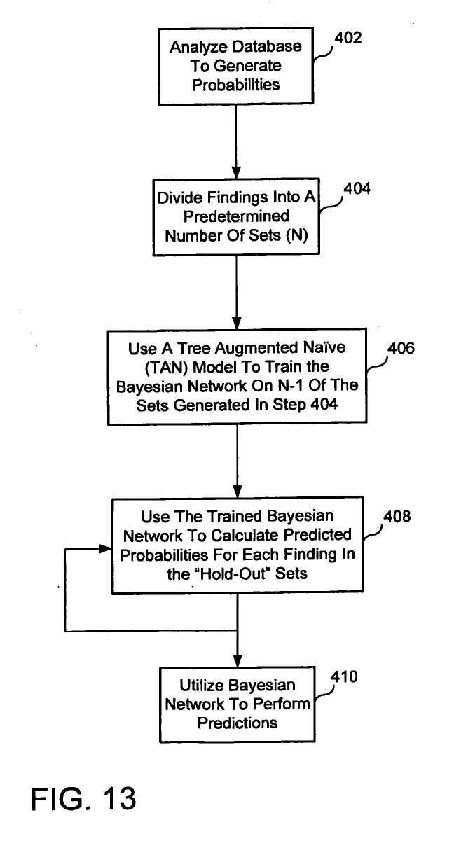

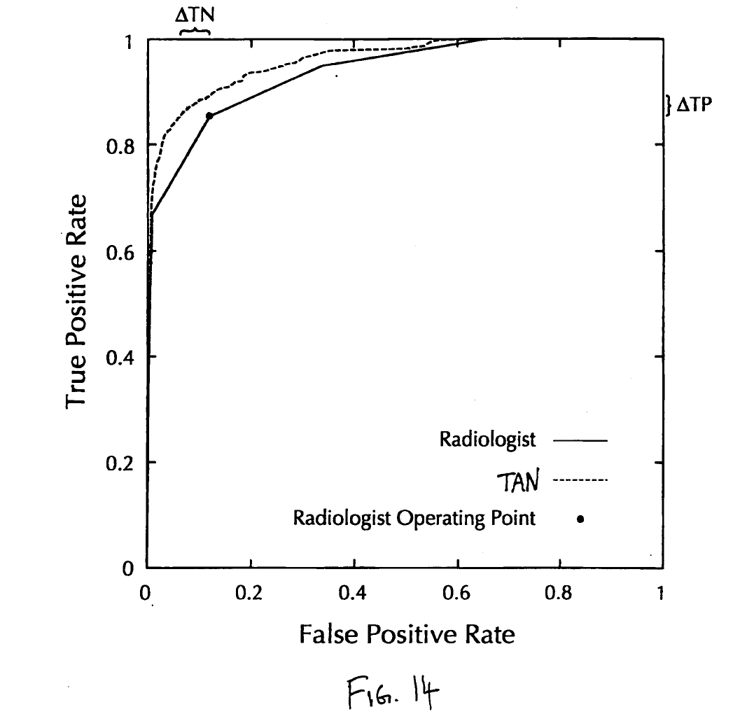

FIG. 13 is a flow chart setting forth the steps for providing another implementation of an automated expert analysis system in accordance with the present invention. In step 402, a database containing a plurality of findings is analyzed to generate probabilities. In the present method, the probabilities are generated using ten-fold cross-validation, however other cross-validation methods may be employed (for example, N-fold cross-validation). The findings may be found in historical mammography data and denote a single record for normal mammograms or each record denoting an abnormality on a mammogram.

To perform ten-fold cross validation, the findings are first divided into ten sets, each with approximately one tenth of the malignant findings and one tenth of the benign findings in step 404. TAN is then used to train the Bayesian network on nine of the ten sets in step 406. The trained Bayesian network is then used to calculate predicted probabilities for each finding in the remaining set (the “held-out” tenth) in step 408 for validation. The training and testing procedure may be repeated multiple times for calculating probabilities for the findings in each held-out set, respectively. The predicted probabilities from the ten held out sets are pooled and can be used to calculate performance statistics. Ten-fold cross validation may minimize the risk that cases originally used to train the model are also used for testing that model at a later time. When using cross validation on a database, for example, the fact that some of the findings are related presents a potential methodological pitfall. As such, a single patient having multiple findings in both the training and the test sets represents leakage of information which can result in overoptimistic performance measures. To avoid this bias, the ten-fold cross-validation methodology may provide that all findings associated with a particular patient are placed into the same set for cross-validation.

After generating probabilities using ten-fold cross-validation, the Bayesian network may be utilized in step 410. In the present example, to evaluate the effectiveness of the Bayesian network, ROC curves are constructed. FIG. 14 is a graph showing example ROC curves constructed from BI-RADS categories of the radiologists, and the predicted probabilities of the Bayesian network. In the figure, ΔTN indicates a change in true negatives which results in improved specificity, and ΔTP indicates a change in true positives which results in improved sensitivity. The radiologist's operating point is considered the BI-RADS 3 point corresponding to a threshold above which biopsy would be recommended.

The ROC curves may be constructed by calculating sensitivity and specificity using each of the possible predicted probabilities of malignancy as the threshold value for predicting malignancy. For example, BI-RADS categories may be used as ordinal response variables to reflect the increasing likelihood of breast cancer (BI-RADS category 1<2<3<4<5). ROC curves may be generated for all radiologists in aggregate as well as for each individual radiologist. After constructing the ROC curves, the areas under the ROC curves (AUC) are calculated and compared, for example, using the DeLong method.

In the present implementation, baseline sensitivity and specificity of the radiologists (again in aggregate) are calculated at the operating point of BI-RADS 3 because above level 3, biopsy would be recommended. The Bayesian network sensitivity at the baseline specificity of the radiologists and the Bayesian network specificity at the baseline sensitivity of the radiologists may then be obtained by linear interpolation from the Bayesian ROC curve. Sensitivity and specificity between radiologists and the Bayesian network may be compared using a chi-squared comparison of proportions.

Having constructed the Bayesian network, it is possible to implement the Bayesian network and determine whether the Bayesian network, when applied to the original findings, affects biopsy rates, recall, or follow-up recommendations.

In one specific example, the present method is applied to a database containing 48,744 consecutive mammography examinations performed on 18,270 patients from Apr. 5, 1999 to Feb. 9, 2004. The following table illustrates a performance of a Bayesian network within BI-RADS categories as a function of probability threshold applied to the database.

| | | Probability Threshold (%) | | | | | | | |
|---|---|---|---|---|---|---|---|---|---|
| | | 0.05 | 0.1 | 0.5 | 1.0 | 2.0 | 3.0 | 4.0 | 5.0 |
| BI-RADS 0 | FP → TN | 3836 | 4286 | 5781 | 6109 | 6296 | 6409 | 6479 | 6524 |
| | TP → FN | 3 | 5 | 21 | 24 | 28 | 31 | 36 | 38 |
| BI-RADS 4 | FP → TN | 16 | 18 | 28 | 59 | 119 | 167 | 198 | 206 |
| | TP → FN | 2 | 3 | 5 | 7 | 12 | 15 | 15 | 16 |
| BI-RADS 5 | FP → TN | 0 | 0 | 0 | 0 | 1 | 2 | 3 | 4 |
| | TP → FN | 0 | 0 | 0 | 0 | 0 | 1 | 2 | 2 |
| BI-RADS 2 | FN → TP | 7 | 4 | 0 | 0 | 0 | 0 | 0 | 0 |
| | TN → FP | 2621 | 1620 | 523 | 284 | 143 | 104 | 75 | 58 |
| BI-RADS 3 | FN → TP | 28 | 24 | 21 | 15 | 5 | 4 | 4 | 3 |
| | FN → TP | 4219 | 2680 | 1218 | 753 | 409 | 309 | 234 | 189 |

In the above chart, findings for which the Bayesian network corrected an erroneous assessment by the radiologist are underlined. These include conversions from false positive to true negative for BI-RADS 0, 4 and 5 and conversions from false negative to true positive for BI-RADS 2 and 3. Conversely, non-underlined entries signify erroneous conversions made by the Bayesian network on findings correctly assessed by the radiologists.

As applied in the present example, TAN may identify predictive variables that are dependent on one another. Some exemplary dependency relationships are shown by the directed arcs in FIG. 4.

The present Bayesian network works differently from conventional CAD algorithms that provide a mark on the image (adding yet another variable to the radiologist's long list of breast cancer predictors). The present Bayesian network provides a post-test probability which consolidates predictive variables in the NMD (demographic variables, mammography descriptors, and BI-RADS assessment categories) into a probability of malignancy. Depending upon the implementation, the inclusion of several BI-RADS variables may ameliorate errors. The present system may be trained on consecutively collected mammography findings, allowing it to more accurately estimate post-test probabilities and better balance improvements in sensitivity and specificity with more realistic estimates of breast cancer prevalence.

The Bayesian network also differs from general risk prediction models, like the Gail model, which predict the probability that a woman will develop breast cancer sometime in the future. In contrast, the present system estimates breast cancer risk at the present time (i.e., the time a mammography is performed). Accordingly, a woman at high risk for breast cancer using general risk models can have a finding with a low probability of malignancy at the present time. Similarly, a woman at low risk using general risk models can have a finding with a high probability of malignancy at the present time, depending on her mammography findings. As such, the present system is more appropriate for driving management decisions such as recall or biopsy.

The present invention has been described in terms of the various embodiments, and it should be appreciated that many equivalents, alternatives, variations, and modifications, aside from those expressly stated, are possible and within the scope of the invention. Therefore, the invention should not be limited to a particular described embodiment.

1. A system for determining a likelihood of a disease:
a patient history database containing records each having a plurality of data fields related to a particular patient;
an analyzing network having access to the patient history database and having a plurality of features based on the plurality of data fields included in the records to analyze the plurality of data fields to determine a likelihood of the disease based on the plurality of features; and
a learning network having access to the analyzing network to review the likelihood of the disease determined by the analyzing network and the plurality of data fields included in the records and automatically identify, evaluate, and add new features to the analyzing network that at least improve determinations of a likelihood of the disease.

2. The system of claim 1 wherein the learning network is configured to only add a new feature to the analyzing network if the new feature would improve the results of determining a likelihood of the disease by greater than a threshold.

3. The system of claim 2 wherein the threshold includes a two percent increase in detection results.

4. The system of claim 2 wherein the threshold includes improving the results of determining a likelihood of the disease in at least five percent of the determinations.

5. The system of claim 1 wherein the at least one of the plurality of data fields related to a particular patient includes a medical image.

6. The system of claim 5 wherein the medical image includes a mammogram and another of the plurality of data fields includes a CAD report.

7. The system of claim 1 wherein the learning network is further configured to add new data fields to the database to store data corresponding to the new features.

8. The system of claim 1 wherein the analyzing network includes a Bayesian network.

9. The system of claim 1 wherein the analyzing network can be selectively enabled and disabled.

10. The system of claim 1 wherein the disease is cancer.

11. A method for developing a system for determining a likelihood of a disease:
providing a database of patient records;
building a Bayesian network to access the database of patient records, analyze a particular patient record in the database, and provide a likelihood of the disease in a patient corresponding to the particular patient record; and
automatically augmenting the Bayesian network using a learning network having access to the Bayesian network to review the likelihood of the disease determined by the analyzing network and the patient records, wherein the augmentation includes adding new features to the Bayesian network that improve determinations of a likelihood of the disease.

12. The method of claim 11 wherein the step of adding new features to the Bayesian network includes adding new features not corresponding to fields in the patient records.

13. The method of claim 12 further comprising adding fields to the patient records corresponding to the new features.

14. The method of claim 11 wherein the addition of a new feature to the analyzing network is only performed if the new feature would improve the results of determining a likelihood of the disease by greater than a threshold.

15. A system for determining a disease state:
a patient history database containing records each having a plurality of data fields related to a particular patient;
a Bayesian network having access to the patient history database and having a plurality of features based on the plurality of data fields included in the records to analyze the plurality of data fields and determine a disease state of a particular patient; and
a learning network having access to the Bayesian network to review the determined disease state and the plurality of data fields included in the records and automatically identify and evaluate potential new features that, if added to the Bayesian network, would improve determinations of the disease state.

16. The system of claim 15 wherein the learning network is configured to only add a potential new feature to the Bayesian network if the potential new feature would improve the determinations of the disease state by greater than a threshold amount.

17. The system of claim 16 wherein the threshold includes a two percent increase in the proper determination of the disease state.

18. The system of claim 15 wherein the threshold includes causing an increase in the proper determination of the disease state in at least five percent of the historical determinations.

19. The system of claim 15 wherein the patient history database includes Breast Imaging Reporting and Data System (BI-RADS) information.

20. The system of claim 15 wherein the learning network utilizes a score as you use (SAYU) protocol.
